(19) United States
(12) Patent Application Publication
(10) Pub. No.: US 2025/0343693 A1
(43) Pub. Date: Nov. 6, 2025

(54) METHOD, DEVICE, AND MEDIUM FOR IMPROVING LATENCY

(71) Applicant: Bytedance Technology Ltd., Grand Cayman (KY)

(72) Inventors: Ziheng JIANG, Los Angeles, CA (US); Ziyi ZHANG, Los Angeles, CA (US); Chengquan JIANG, Los Angeles, CA (US); Haibin LIN, Los Angeles, CA (US); Xin LIU, Los Angeles, CA (US)

(21) Appl. No.: 19/269,729

(22) Filed: Jul. 15, 2025

(51) Int. Cl. H04L 9/32; G06T 1/20

(52) U.S. Cl. CPC H04L 9/3213; G06T 1/20

(57) ABSTRACT

Embodiments of the present disclosure provide a method, device, and medium for improving latency. The method comprises receiving a plurality of verified tokens. And the method further comprises generating, by the first model and based on the plurality of verified tokens, a plurality of candidate tokens. And the method further comprises sending the plurality of candidate tokens to the second model, wherein the first model is allocated to at least one first processor, and the second model is allocated to at least one second processor, and the at least one first processor is used for computation of the first model, and the at least one second processor is used for computation of the second model respectively, and the computation of the second model is carried out in parallel during the computation of the first model.

### BACKGROUND

The remarkable capacity of large language models (LLMs) to learn from vast datasets has been instrumental in enabling the rapid proliferation of emerging applications across diverse domains, including chatbots, search, and personalized recommendation systems.

### SUMMARY

In a first aspect according to some embodiments of the present disclosure, a method for improving latency comprises receiving a plurality of verified tokens. And the method further comprises generating, by the first model and based on the plurality of verified tokens, a plurality of candidate tokens. And the method further comprises sending the plurality of candidate tokens to the second model, wherein the first model is allocated to at least one first processor, and the second model is allocated to at least one second processor, and the at least one first processor is used for computation of the first model, and the at least one second processor is used for computation of the second model respectively, and the computation of the second model is carried out in parallel during the computation of the first model.

In a second aspect according to some embodiments of the present disclosure, an electronic device comprising a memory and a processor is provided. The memory is configured to store computer instructions which, when executed by the processor, cause the processor to receive a plurality of verified tokens. The instructions further cause the processor to generate, by the first model and based on the plurality of verified tokens, a plurality of candidate tokens. In addition, the instructions further cause the processor to send the plurality of candidate tokens to the second model, wherein the first model is allocated to at least one first processor, and the second model is allocated to at least one second processor, and the at least one first processor is used for computation of the first model, and the at least one second processor is used for computation of the second model respectively, and the computation of the second model is carried out in parallel during the computation of the first model.

In a third aspect according to some embodiments of the present disclosure, a non-transitory computer-readable medium is provided. The medium comprises instructions stored thereon which, when executed by a processor, cause the processor to receive a plurality of verified tokens. The instructions further cause the processor to generate, by the first model and based on the plurality of verified tokens, a plurality of candidate tokens. In addition, the instructions further cause the processor to send the plurality of candidate tokens to the second model, wherein the first model is allocated to at least one first processor, and the second model is allocated to at least one second processor, and the at least one first processor is used for computation of the first model, and the at least one second processor is used for computation of the second model respectively, and the computation of the second model is carried out in parallel during the computation of the first model.

Any of the one or more above aspects in combination with any other of the one or more aspects is described herein. This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Embodiments of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 shows an overall architecture and application scenario in which one or more embodiments of the present disclosure may be implemented according to some embodiments of the present disclosure;

FIG. 2 is a flow chart illustrating an example process for improving latency according to some embodiments of the present disclosure;

FIG. 3 is a flow chart illustrating an example token verification process for improving latency according to some embodiments of the present disclosure;

FIG. 4 shows a more detailed overall schematic structure illustrating an example architecture for improve latency according to some embodiments of the present disclosure;

FIG. 5 shows an example of parallel tree generation process according to some embodiments of the present disclosure;

FIG. 6 shows a parallel tree generation algorithm according to some embodiments of the present disclosure;

FIG. 7 shows an example of a non-square tree mask during draft tree expansion according to some embodiments of the present disclosure;

FIG. 8 shows an example of how the KV cache of the draft model is updated when there are new verified tokens according to some embodiments of the present disclosure;

FIG. 9 shows the computation and data flow of the process within one thread block when some embodiments of the present disclosure run GEMM fused with all reduce;

FIG. 10 is a block diagram illustrating physical components (for example hardware) of an electronic device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents. A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “comprising” used herein and variations thereof are an open-ended inclusion, namely, “comprising but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description. Concepts such as “first” and “second” mentioned in the present disclosure are only for distinguishing different apparatuses, modules, or units, and are not intended to limit the order or relation of interdependence of functions performed by these apparatuses, modules, or units. Variants of “one” and “a plurality of” mentioned in the present disclosure are illustrative and not restrictive, and those skilled in the art should understand that unless otherwise explicitly specified in the context, the modifiers should be understood as “one or more”. The names of messages or information exchanged between apparatuses in the implementations of the present disclosure are provided for illustrative purposes only, and are not used to limit the scope of these messages or information. Data (comprising the data itself, and data acquisition, or usage) involved in the technical solutions should comply with the requirements of corresponding laws and regulations, and relevant stipulations.

As mentioned above, LLMs become more and more popular. However, real-time applications etc., such as interactive code assistants and robotics, impose stringent limits on models' decoding latency. Recently, Chain-of-thought (CoT) is also increasingly adopted to improve reasoning quality. A single CoT inference can decode tens of thousands of tokens and take more than ten minutes to complete. Reducing decoding latency is, therefore, critical.

In LLM-serving systems, there is an inherent trade-off between throughput and latency under the same compute resources. This work investigates how to achieve ultra-low latency decoding in single-request scenarios, where existing serving frameworks-designed to maximize throughput under service-level-objective (SLO) constraints—often fall short. For instance, a 4-bit quantized LLM running on 8 GPUs can take approximately 30 s to generate a response of about 3,000 tokens when deployed with the popular LLM serving frameworks.

Present speculative decoding accelerates LLM inference in single-request scenarios. Speculative de-coding consists of two distinct phases of a draft phase followed by a verification phase. During the draft phase, a relatively small draft model rapidly generates a sequence of candidate tokens (and, in some vari-ants, a tree-structured set of candidates). During the subsequent verification phase, a significantly larger target model validates all candidates by performing a batch inference, thereby emitting multiple tokens at once and reducing decoding latency. Prior work typically treats the draft and verification phases as strictly sequential operations because of their data dependencies. This design places the draft phase on the critical path as an additional overhead, preventing speculative decoding from fully realizing its latency-reduction potential.

Tensor parallelism is another technique to reduce the decoding latency by scaling the computation resources. Tensor parallelism partitions the model weights across multiple GPUs and then performs all-reduce operations to aggregate the partial results. However, a straightforward combination of tensor parallelism with speculative decoding is ineffective. In speculative decoding, the draft and target models are co-located on the same devices.

Because the two models differ greatly in size, applying the same degree of tensor-parallelism to both cannot yield optimal system latency. The smaller draft model reaches the point of diminishing returns sooner. Once its weights are already finely shard, further increasing the tensor-parallelism no longer reduces latency, because other overheads, most notably inter-GPU communication, dominate.

Therefore, it can be seen that a method or system is needed to solve at least one of the above multiple problems. The present disclosure proposes an interaction method, device, system, medium, etc. for improving latency. One or more embodiments of the present disclosure propose redesigning the speculative decoding pipeline in an asynchronous and disaggregated manner, so that each component can be scaled flexibly and remove draft overhead from the critical path.

Exemplarily, the embodiments of the present disclosure propose a method suitable for improving the latency. The method comprises receiving a plurality of verified tokens. And the method further comprises generating a plurality of candidate tokens by a first model and based on the plurality of verified tokens. And the method further comprises sending the plurality of candidate tokens to a second model, wherein the first model is allocated to at least one first processor, and the second model is allocated to at least one second processor, and the at least one first processor is used for computation of the first model, and the at least one second processor is used for computation of the second model respectively, and the computation of the second model is carried out in parallel during the computation of the first model. In this way, the embodiments of the method can improve the latency greatly.

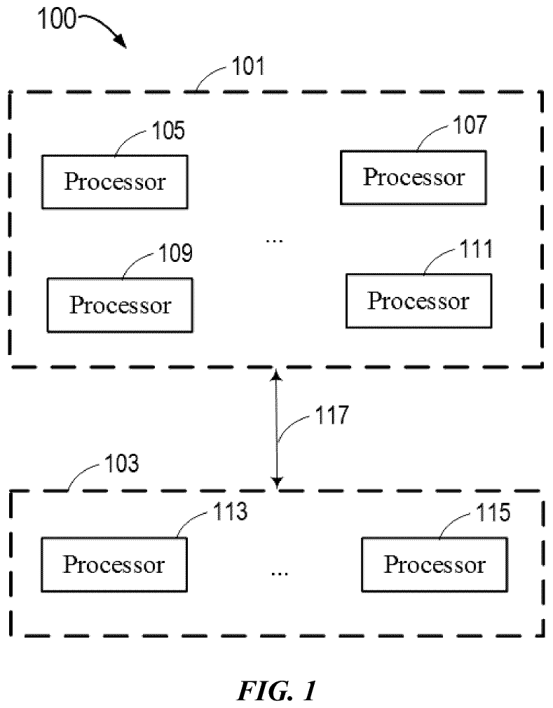

FIG. 1 shows an overall architecture and application scenario 100 in which one or more embodiments of the present disclosure may be implemented according to some embodiments of the present disclosure. The architecture 100 is totally different from the traditional overall architecture of the LLM. The traditional overall architecture of the LLM deploys the LLM to a whole group of processers. In contrast, the architecture 100 may include two groups of processors 101 and 103. The first group of processors 101 may include at least one processor, such as processors 105, 107, 109 and 111 etc. And the second group of processors 103 may include at least one processor, such as processors 113 and 115 etc. In some embodiments of the present disclosure, the first group of processors 101 and the second group of processors 103 may communicate synchronously at 117. In some embodiments of the present disclosure, a first model may be allocated to the second group of processors 103, and a second model may be allocated to the first group of processors 101, and the second group of processors 103 may be used for computation of the first model, and the first group of processors 101 may be used for computation of the second model respectively, and the computation of the second model is carried out in parallel during the computation of the first model.

In some embodiments of the present disclosure, a number of parameters of the second model is greater than a number of parameters of the first model. In some embodiments of the present disclosure, the first model may be a small draft model of the LLM, and the second model may be a larger target model of the LLM. In some embodiments of the present disclosure, the processors 105, 107, 109, 111, 113 and 115 etc. may be Graphics Processing Units (GPUs), and the GPUs may use a Collective Communication Library's Low Latency (CCL LL) protocol for the synchronous communication. It is worth noting that the number of processors in each group 101 or 103 in the FIG. 1 is merely exemplary and does not constitute a limitation on the protection scope of the present disclosure. Those skilled in the art can adjust the number of processors in each group according to actual needs. Any number of processors in each group 101 or 103 suitable for the present disclosure should be within the scope of the present disclosure. In addition, the present disclosure does not particularly limit the type of processor. Any type of processor suitable for the present disclosure should be within the protection scope of the present disclosure. In this way, the embodiments of the method can improve the latency of the LLM greatly.

Next, multiple embodiments of the present disclosure will be described in detail with reference to the relevant drawings and based on the overall schematic flow chart and application scenario 100 according to one or more embodiments of the present disclosure.

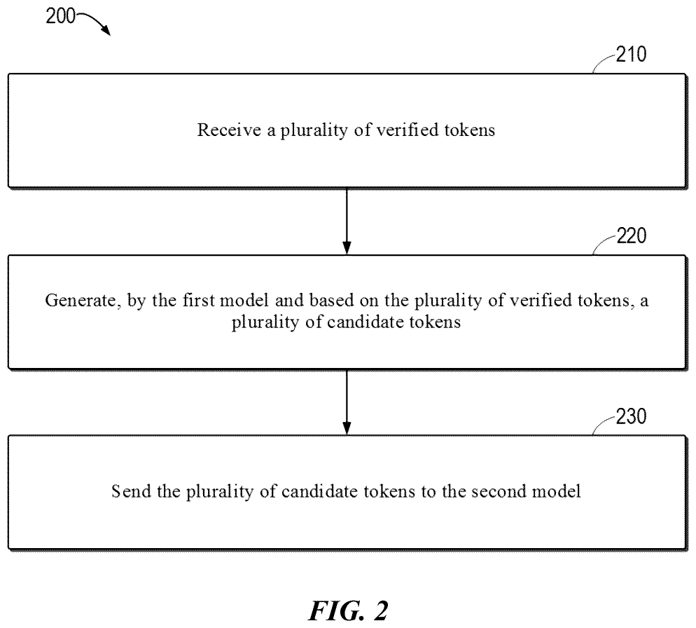

FIG. 2 is a flow chart illustrating an example process 200 for improving latency according to some embodiments of the present disclosure. The example interaction process 200 may be implemented by a computing device, and may be implemented in the overall schematic flow chart and application scenario 100. The present disclosure does not specifically limit the specific implement of the process 200. Any suitable implement of process 200 for the present disclosure should be within the protection scope of the present disclosure. As shown in FIG. 2, at block 210, a plurality of verified tokens may be received. In some embodiments, a first model may be allocated to at least one first processor, and a second model may be allocated to at least one second processor, and the at least one first processor may be used for computation of the first model, and the at least one second processor may be used for computation of the second model respectively, and the computation of the second model may be carried out in parallel during the computation of the first model.

At block 220, a plurality of candidate tokens may be generated by the first model based on the plurality of verified tokens. In some embodiments, generating, by the first model and based on the plurality of verified tokens, the plurality of candidate tokens may comprises traversing a draft tree, wherein the draft tree includes the plurality of candidate tokens, and re-rooting, based on the plurality of verified tokens, the draft tree. In some embodiments, generating, by the first model and based on the plurality of verified tokens, the plurality of candidate tokens further comprises expanding the draft tree, wherein sending the plurality of candidate tokens to the second model comprises in response to the number of the nodes of the draft tree being greater than or equal to a sending threshold, sending a sub-graph of the draft tree to the second model.

In some embodiments, based on the types of the first model and the second model, a number of the at least one first processor for the first model and a number of the at least one second processor for the second model may be determined at a computing node. In some embodiments, the number of parameters of the second model may be greater than a number of parameters of the first model. In some embodiments of the present disclosure, the first model may be a small draft model of the LLM, and the second model may be a larger target model of the LLM. In some embodiments of the present disclosure, the processors may be GPUs, and the GPUs may use the CCL LL protocol for the synchronous communication. In some embodiments, a batch size of the draft tree may be determined based on a total running time of the first model and the second model. In some embodiments, a number of tree expansions of the draft tree may be determined based on a total running time of the first model and the second model in one iteration.

Furthermore, in some embodiments, the process 200 may further comprise dividing a Key-Value (KV) cache of the first model into a prefix segment and a tree cache segment, wherein the prefix segment is used to store KV states of the plurality of verified tokens of the draft tree, and the tree cache segment is used to store KV states of remaining nodes of the draft tree. In some embodiments, generating, by the first model and based on the plurality of verified tokens, the plurality of candidate tokens may comprise updating, based on the plurality of verified tokens, the prefix segment of the KV cache of the first model, and in response to the plurality of verified tokens existing in the re-rooted draft tree, storing KV states of remaining nodes of the re-rooted draft tree in the tree cache segment. In some embodiments, storing KV states of remaining nodes of the re-rooted draft tree in the tree cache segment may comprise deleting at least one of KV states of the plurality of verified tokens from the tree cache segment.

In additional embodiments, generating, by the first model and based on the plurality of verified tokens, a plurality of candidate tokens may further comprise in response to the number of the nodes of the draft tree being less than a sending threshold, expanding the draft tree to obtain the plurality of candidate tokens. In some embodiments, the process 200 may further comprise determining at least one result matrix of the first model on a current processor of the at least one first processor, and sending the at least one result matrix to all the other processors of the at least one first processor. In some embodiments, the process 200 may further comprise in response to receiving the at least one result matrix, aggregating the at least one result matrix to get at least one final result on at least one of all the other processors, and sending the at least one final result to a global memory of the current processor. In some embodiments, the process 200 may further comprise fusing position embedding with an attention calculation for mask-attention operators for the computation of the first model, or fusing Swish-Gated Linear Unit (SwiGLU) operator based on a tile-based matrix multiplication for the computation of the first model.

Referring now back to FIG. 2, at block 230, the plurality of candidate tokens may be sent to the second model. In some embodiments, the plurality of candidate tokens may be verified by the second model. In some embodiments, the verified plurality of candidate tokens may be sent back to the first model by the second model in next iteration.

In this way, the embodiments of the process 200 redesigns the speculative decoding pipeline in an asynchronous and disaggregated manner, so that each component can be scaled flexibly and remove draft overhead from the critical path. And the embodiments of the process 200 thus change the traditional computation of the small draft model and the large target model to parallel computation, and improve the computation latency greatly.

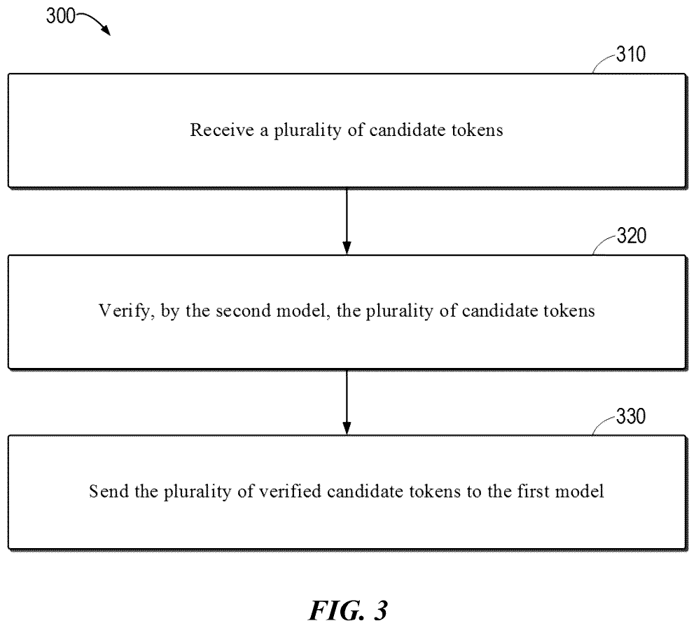

FIG. 3 is a flow chart illustrating an example token verification process 300 for improving latency according to some embodiments of the present disclosure. The example interaction process 300 may be implemented by a computing device, and may be implemented in the overall schematic flow chart and application scenario 100. The present disclosure does not specifically limit the specific implement of the process 300. Any suitable implement of process 300 for the present disclosure should be within the protection scope of the present disclosure. As shown in FIG. 3, at block 310, a plurality of candidate tokens may be received. In some embodiments, the plurality of candidate tokens may be generated and sent by the first model. In some embodiments, the first model may be allocated to at least one first processor, and the second model may be allocated to at least one second processor, and the at least one first processor may be used for computation of the first model, and the at least one second processor may be used for computation of the second model respectively, and the computation of the second model may be carried out in parallel during the computation of the first model.

At block 320, the plurality of candidate tokens may be verified by the second model. In some embodiments, verifying, by the second model, the plurality of candidate tokens may comprise determining a probability distribution of the plurality of candidate tokens of the sub-graph of the draft tree, and sampling the probability distribution of the plurality of candidate tokens of the sub-graph of the draft tree, and determining, based on the sampled probability distribution of the plurality of candidate tokens, the plurality of verified tokens.

At block 330, the plurality of verified candidate tokens may be sent to the first model. In some embodiments, based on the types of the first model and the second model, a number of the first processors for the first model and a number of the second processors for the second model may be determined at a computing node, and a number of parameters of the second model may be greater than a number of parameters of the first model.

In some embodiments, the process 300 may further comprise determining at least one result matrix of the second model on a current processor of the at least one second processor, and sending the at least one result matrix to all the other processors of the at least one second processor. In some embodiments, the process 300 may further comprise in response to receiving the at least one result matrix, aggregating the at least one result matrix to get at least one final result on at least one of all the other processors, and sending the at least one final result to a global memory of the current processor. In some embodiments, the process 300 may further comprise fusing position embedding with an attention calculation for mask-attention operators for the computation of the first model, or fusing SwiGLU operator based on a tile-based matrix multiplication for the computation of the second model.

In this way, the embodiments of the process 300 redesigns the speculative decoding pipeline in an asynchronous and disaggregated manner, so that each component can be scaled flexibly and remove draft overhead from the critical path. And the embodiments of the process 300 thus change the traditional computation of the small draft model and the large target model to parallel computation, and improve the computation latency greatly.

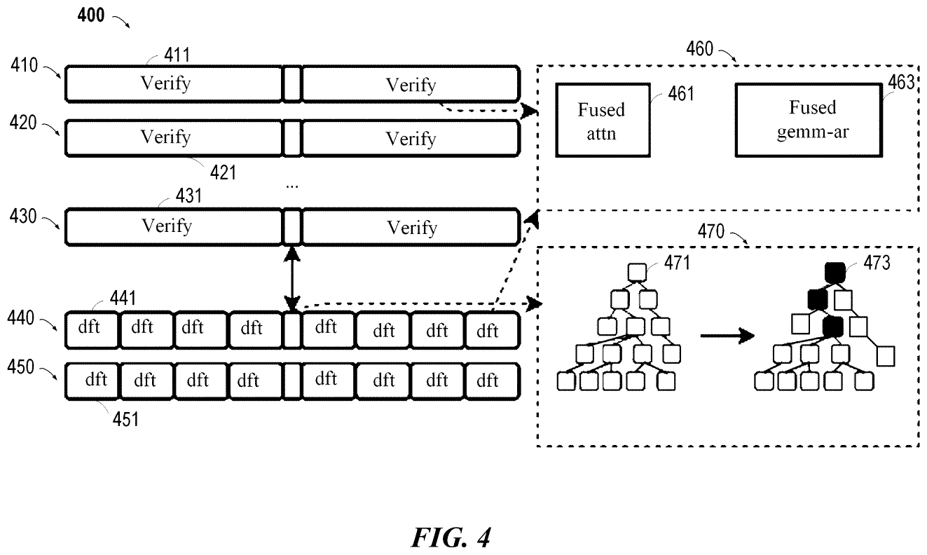

Furthermore, in order to help those skilled in the art better understand the embodiments of the present disclosure, FIG. 4 shows a more detailed overall schematic structure illustrating an example architecture 400 for improve latency according to some embodiments of the present disclosure. In FIG. 4, in order to effectively combine speculative decoding with tensor parallelism and achieve ultra-low decoding latency, the embodiments of the present disclosure redesign the speculative decoding process in an asynchronous, disaggregated manner. That is, the embodiments of the present disclosure partition GPUs into two groups: the verification group (410, 420 and 430 etc.) and the draft group (440 and 450 etc.). Rather than co-located on the same hardware, the target model runs on the verification group, and the draft model runs on the draft group. The verification and draft phases proceed in parallel, that is, while the verification group verifies (411, 421 and 431 etc.) iteration n−1, the draft group concurrently produces candidates (draft tokens (dft) 441, 451 etc.) for iteration n. When a verification iteration is complete, the verification group (410, 420 and 430 etc.) synchronizes the validated tokens with the draft group (440 and 450 etc.) and obtains the next set of candidate tokens to be verified. Under this design, the draft and target models can be flexibly scaled to different degrees of parallelism, and the dependencies between the two phases are decoupled, removing the draft phase from the critical path.

In some embodiments, realizing this design poses three system-level challenges. First, while the verification group is still performing parallel validation and has not yet obtained a definitive answer for the current iteration, the draft group must still generate the candidate set for the next iteration. Second, maintaining key-value cache consistency between complex drafting models (e.g., tree-structured draft models) and the target model is non-trivial. When tree-based draft generation runs in parallel, newly accepted tokens may force the draft model to discard invalid branches. It is important (yet challenging) to keep a consistent view of the KV cache of accepted tokens and the draft tokens that might be useful in the future. Third, hiding communication latency during decoding is challenging. For example, when draft and target models are under tensor parallelism, it is hard to overlap the all-reduce operation with other operations since they usually remain on the critical path. Furthermore, the GPU kernels, usually optimized for higher through-put, have suboptimal performance under low batch sizes, spending most of the time on the latency of data movement and kernel launch.

Next, some embodiments of the present disclosure present a novel system that achieves ultra-low decoding latency for LLMs in FIG. 4, significantly reducing the decoding latency in single-request scenarios. To address the above challenges, the present disclosure introduces: (a) Parallel tree generation (470, 471 and 473 etc.). The embodiments of the present disclosure allocate the draft and target models onto different sets of GPUs, eliminating inter-dependencies and allowing each model to generate tokens or verify them independently. While the target model verifies one batch, the draft model simultaneously produces future candidate tokens, ensuring high GPU utilization. This allows scale each model according to its own compute requirements. (b) Consistent KV cache management. After each verification step, embodiments of the present disclosure carefully reorganize the KV Cache of both the draft and target models to maintain consistency. For the draft model, embodiments of the present disclosure develop a scheme to keep the accepted and future tokens consistent with the draft tree, even when some guesses are incorrect and some part of the draft tree is invalidated. This approach also maximizes the reuse of the previously computed KV cache values. (c) Latency-optimized kernels (460, 461 and 463 etc.). The embodiments of the present disclosure develop latency-optimized kernels that minimize synchronization barriers and unnecessary data transfers, accelerating inference in low-batch scenarios. Using the CCL LL protocol, the embodiments of the present disclosure develop a fused General Matrix to Matrix Multiplication (GEMM) with all-reduce and an attention operator without any explicit synchronization barriers. Furthermore, the embodiments of the present disclosure fuse the multiple operations in the Switched Gated Linear Unit (SwiGLU) operator to decrease latency.

In this way, the embodiments of 400 identify the scalability challenges of speculative decoding under tensor parallelism in existing LLM serving systems. And the embodiments of 400 further provides the system, which integrates techniques including parallel tree generation, consistent KV cache management, and latency optimized kernels to redesign speculative decoding in an asynchronous, disaggregated manner. On the other hand, the embodiments of 400 conduct a comprehensive evaluation of Swift-Spec across five model families and six benchmark datasets, in which the present disclosure consistently outperforms the baselines and achieves significant technical results.

To sum up, the system of the present disclosure, provided by the present disclosure as shown in FIG. 4, addresses the three key systems challenges identified in the prior section through a modular design built around: (1) parallel tree generation, which enables asynchronous decoding and independent GPU allocation; (2) KV-cache consistency management, which supports reuse and correctness under speculative execution; and (3) latency-optimized fused kernels, which reduce communication and compute overhead under tensor parallelism. The embodiments of the present disclosure will describe each component in turn as below.

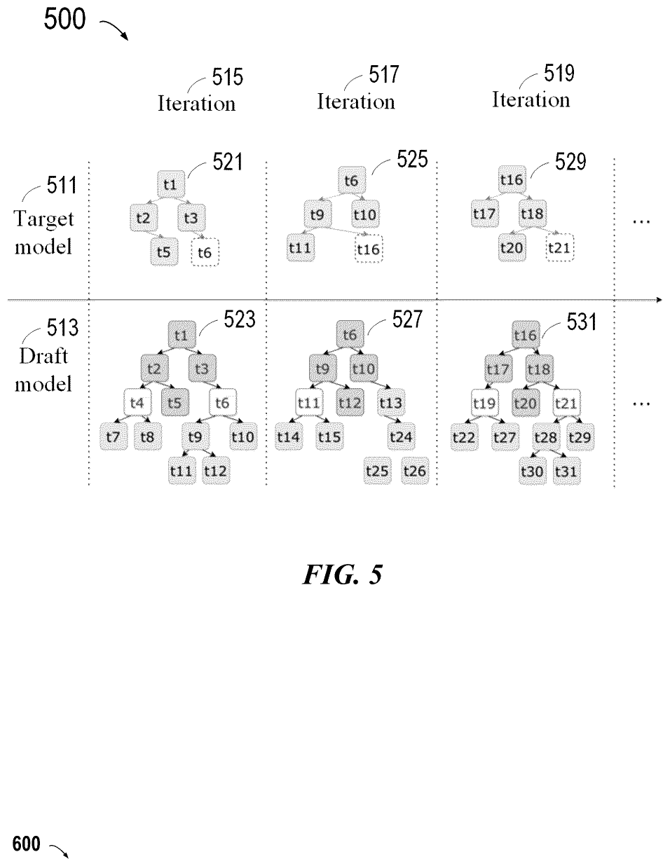

FIG. 5 shows an example of parallel tree generation process 500 according to some embodiments of the present disclosure. In some embodiments, in order to enable independent scaling of draft and target models (511, 513), some embodiments of the present disclosure introduce parallel tree generation, which splits the decoding process across GPU groups separately dedicated to drafting and verification. That allows both models to operate concurrently and avoids placing the draft phase on the critical path. The two groups communicate using NVLink/cross-network interconnect. The draft tree GPUs manage the draft tree and run draft inference to generate new tree nodes, while the target GPUs run the target model. Both the draft and target models (511, 513) are split across their respective GPUs through tensor parallelism (TP). GPUs computing the same model are connected tightly using NVLink.

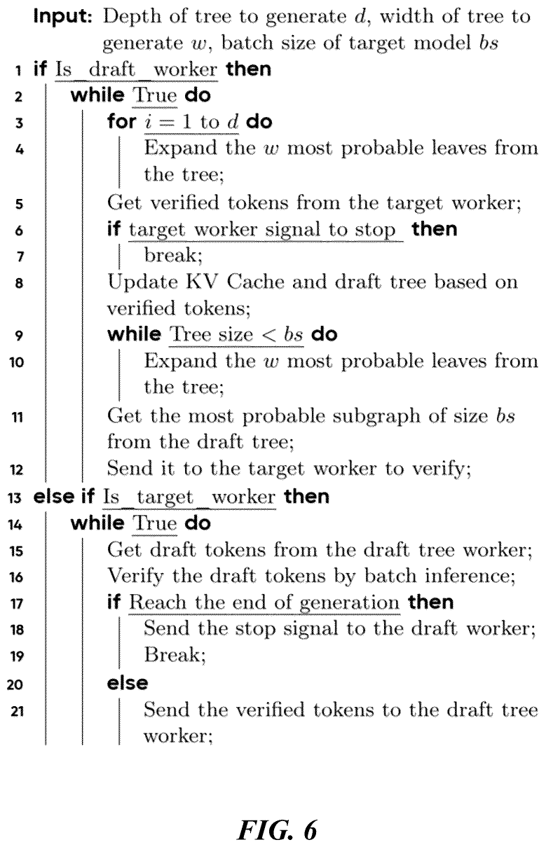

FIG. 6 shows a parallel tree generation algorithm 600 according to some embodiments of the present disclosure. The algorithm 600 details the interaction between draft and target models in each decoding iteration. Denote one round (or one iteration) as the procedures of the draft and target model between two synchronization points. Define bs as the batch size of the target model, w as the number of leaves for which some embodiments of the present disclosure run the draft model inference (and thus expand the leaves to get potential children) each round (i.e., the batch size of the draft model), d as the number of tree expansions in one round. Both target worker and draft worker run in a loop until the end of the generation, and synchronize when each finishes one iteration in the loop.

Referring now back to FIG. 5, in some embodiments, in one iteration 515, the draft worker of the draft model 513 expands the draft tree 523 d times, by running inference on w unexpanded leaves (i.e., the leaves where the KV-cache and logits (probability distribution of the next token) are not yet calculated) from the tree with the highest probability. After that, it synchronizes with the target worker to get the verified tokens. Then it re-roots the draft tree 527 by walking down the tree using the path representing the verified tokens and adjusts the KV cache to stay consistent. After that, it grows the draft tree 527 if there are not enough nodes to send to the target, and then it sends a sub-graph of the draft tree of size bs to the target worker.

On the other hand, in one iteration 515, the target model 511 constantly gets the draft tokens from the draft tree (523, 527 or 531) and runs batch inferences to calculate the logits. After that, it samples through the logits to generate the tokens one by one and then sends the verified tokens back to the draft worker.

FIG. 5 shows three decoding iterations 515, 517 and 519. In each iteration, the draft model 513 grows the trees 523, 527 and 531, while the target model 511 verifies a subgraph. The trees 523, 527 and 531 are then re-rooted, and verified tokens are promoted to the KV cache. In this example, bs=4, d=3, w=2. At the start, the draft tree 523 is t1, t2, t3, t4, t5, t6, and the draft workers select the top bs=4 tokens (t1, t2, t3, t5) to give as input1 to the target workers of the target model 511. During iteration 515, while the draft workers continue growing the tree with 6 new nodes, the target workers run inference on input1 and sample output1=(t1, t3, t6). Then, the draft workers verify that (t1, t3, t6) is a valid path in the tree 527 and re-root at t6. With enough nodes remaining, they choose the next top 4 tokens (t6, t9, t10, t11) as input2. During iteration 517, the draft workers grow 6 more nodes while the target workers process input2 and produce output2 = (t6, t9, t16). However, t16 is not yet in the tree 527, so the draft workers re-root at t16 and keep growing new nodes t17, t18, t19, t20, t21, giving (t16, t17, t18, t20) as input3 at the tree 527. During iteration 519, a similar process continues, with the draft and target workers running in parallel, growing and verifying 11 tokens as they build out the trees 529 and 531.

Furthermore, some embodiments of the present disclosure also provide a maximum-likelihood tree expansion. Some embodiments of the present disclosure use the logarithm of the softmax probability as the value of each node, and use the sum of values from the root to each node as the weight. Thus, a higher weight means a higher probability that a token could be generated (under the distribution of the draft model). Some embodiments of the present disclosure keep the pair (value, node) in a priority queue to efficiently get the most probable leaves in O (k log s), where s is the number of probable leaves to consider and expand the tree.

Furthermore, some embodiments of the present disclosure further consider the GPU allocation for the draft model and the target model. Given a GPU node of k GPUs, some embodiments of the present disclosure will allocate x (1≤x≤k−1) GPUs to the target model and (k−x) GPUs to the draft model. To determine which x to use, some embodiments of the present disclosure run a profile phase before serving the queries, where some embodiments of the present disclosure try out different xs to find which configuration yields the fastest average decoding speed. Some embodiments of the present disclosure found that if some embodiments of the present disclosure fix the target model, the optimal x is smaller when some embodiments of the present disclosure are using a more powerful target model.

Furthermore, some embodiments of the present disclosure further set the batch size. Larger bs, w will lead to higher acceptance ratio per iteration, but when bs, w get larger and larger, the margin gain on the acceptance ratio will decrease, and total running time will increase. Some embodiments of the present disclosure set bs=8 and w=8 empirically to balance the acceptance ratio and running time.

Furthermore, some embodiments of the present disclosure further set the number of tree expansions d in one round. Before some embodiments of the present disclosure start serving the requests, some embodiments of the present disclosure first profile the running time of both the draft model and the target model. Denote t_{target} as one round of target model inference, and t_{draft} as one round of draft tree expansion. Define

$$r = ⌊ \frac{{t}_{target}}{{t}_{draft}} ⌋ .$$

Some embodiments of the present disclosure set d=r or d=r+1, so that draft tree expansion and the target model verification finish nearly at the same time to maximize parallelism.

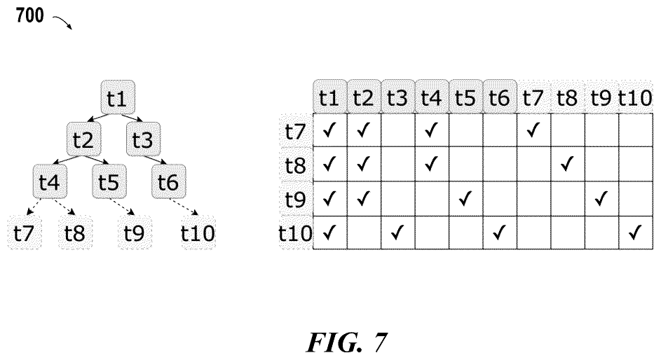

Furthermore, some embodiments of the present disclosure further provide non-square mask support for efficient masked attention kernel. The attention operator in the target model uses a square mask, since the target model takes a tree each time, and each token will only mask out the attention with those tokens that are not the ancestors within the current input. However, for the draft model, this is not the case. FIG. 7 shows an example of a non-square tree mask during draft tree expansion according to some embodiments of the present disclosure, wherein nodes t7, t8, t9 and t10 are the leaves to expand, and nodes t1, t2, t3, t4, t5 and t6 are the existing tree nodes, the right table shows the relationship of the nodes. Consider the example with a current tree of size 6 in FIG. 7, and some embodiments of the present disclosure calculate the logits of 4 probable leaves, then regarding the tree cache, some embodiments of the present disclosure only calculate the attention of each leave with its ancestor on the tree (and also all the data that is in the prefix cache). In this case, some embodiments of the present disclosure need a mask of at least size (4, 10) to contain all the necessary information. Therefore, some embodiments of the present disclosure support a non-square mask as input in our attention operator for the draft model.

In this way, the embodiments of 500 identify the scalability challenges of speculative decoding under tensor parallelism in existing LLM serving systems. And the embodiments of 500 further integrates parallel tree generation to redesign speculative decoding in an asynchronous, disaggregated manner, and improves the latency for LLM greatly etc., and achieved significant technical results.

Next, some embodiments of the present disclosure will explain the KV Cache Consistency Management in details. To maintain the consistency between the draft model and target model, some embodiments of the present disclosure develop a consistency management scheme to reorganize the KV cache of the draft model so that it remains consistent with the target model and the draft tree and maximizes the re-use of previously computed KV states. Throughout the execution, some embodiments of the present disclosure organize the KV Cache of the draft model as follows and keep it as an invariant throughout the execution: the KV states of the verified tokens are stored continuously in the prefix of the KV cache (which some embodiments of the present disclosure call prefix cache), and the KV states of the tree are stored right after the prefix (which some embodiments of the present disclosure may call tree cache). In some embodiments, while the target worker is doing batch inference and sampling on the tokens from the draft workers, the draft worker keeps generating new tree leaves in the draft tree, appending the tree cache after the existing entries.

Furthermore, some embodiments of the present disclosure may provide re-organization of KV cache for verified tokens. After the target worker samples the tokens, it sends the verified tokens to the draft worker. The draft worker then walks through the tree using the verified tokens and re-roots at the last verified token. Then, if the last verified token exists in the current draft tree, then some embodiments of the present disclosure will reorganize the tree cache so that only the KV states of the nodes in the new subtree remain in the tree cache. In this way, even when some of the predicted tokens some embodiments of the present disclosure send to the target worker are wrong, some embodiments of the present disclosure can still reuse all the computed KV states in the subtree, avoiding any re-computation.

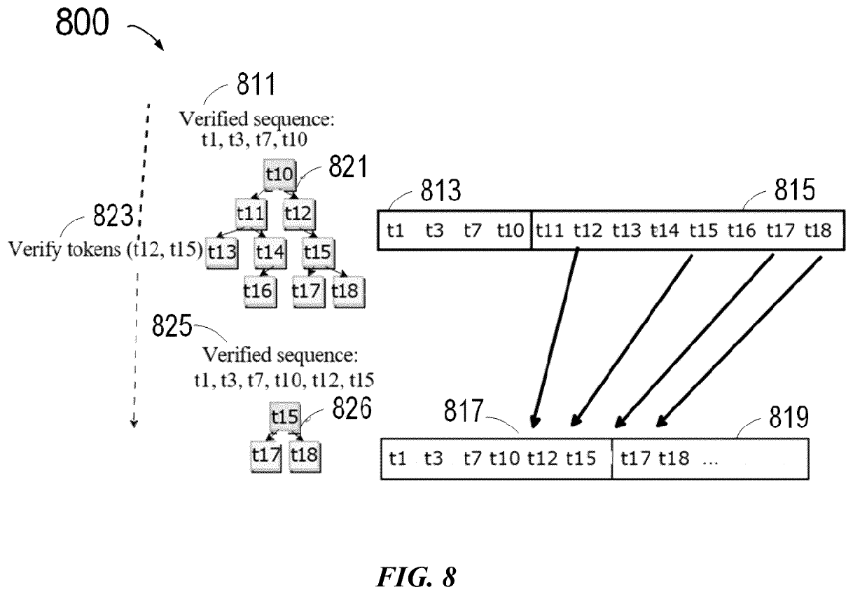

FIG. 8 shows an example method 800 of how the KV cache of the draft model is updated when there are new verified tokens according to some embodiments of the present disclosure. Each time after the new verified tokens get updated, the KV states of the verified tokens will be in the prefix of the KV cache (813, 817), and the KV states of the draft tree tokens will be right after the prefix (815, 819). Suppose the sequence 811 (t1, t3, t7, t10) is already verified as the draft tree 821, and the prefix of the cache 813 is the KV states of those tokens, and the KV states of the draft tree tokens are organized contiguously after the prefix in the tree cache 815. When some embodiments of the present disclosure update the verified tokens to be (t1, t3, t7, t10, t12, t15) 825, some embodiments of the present disclosure walk down the draft tree using the newly verified tokens (t12, t15) which are verified at 823. Then some embodiments of the present disclosure reach the node t15, which means the nodes in the subtree 826, nodes t17 and t18 are still useful in 819 in the future. Therefore, some embodiments of the present disclosure move t12 and t15 to the prefix cache 817, and that it stores the information of the same verified tokens as the target model. Then it reorganizes the remaining sub-tree of t15 (i.e. t17, t18) into the next positions available, discarding the KV states that are no longer useful (e.g. t11, t12, etc.).

In the case where the draft tree does not have enough nodes to send back to the target worker, it expands bs nodes immediately using one draft model inference. In either case, the draft tree will have enough nodes to pass to target workers, therefore entering the next iteration, with the KV states synchronized across the draft model, the target model, and the draft tree. In this way, some embodiments of the present disclosure avoid re-computation greatly and save much cost.

Next, some embodiments of the present disclosure will provide a latency-optimized kernels design in details. To reduce the inference time of both draft and target under low batch size, some embodiments of the present disclosure design and implement latency-optimized operators for a LLM family. While the design could be applied to any precision. The operators some embodiments of the present disclosure optimize include all-reduce, masked attention, and SwiGLU. Some embodiments of the present disclosure may introduce the CCL LL protocol, which our work leverages CCL LL protocol. This is a communication scheme to reduce the latency of GPU-to-GPU send and receive operations. CCL LL protocol includes the store and load function of the LL protocol. The functions AtomicStore and AtomicLoad are GPU PTX instructions ld.volatile.global.v4.u32 and st.volatile.global. v4.u32, which load and store 16 bytes of data from and to the global memory in the same or different GPUs. And each 8-byte (2 32-bit unsigned integers) load/store is atomic.

Specifically, the storeLL function takes a 64-bit integer val and a 32-bit integer flag, splits val into two 32-bit integers, and stores them each with flag to a memory location. The loadLL function takes a memory location and a flag. It keeps polling until the flag at the memory location matches the expected one, and then combines the 2 32-bit integers into a 64-bit integer to return.

Using those two functions, some embodiments of the present disclosure can implement a communication scheme without any explicit synchronization. Assume that last time some embodiments of the present disclosure store some value x as a flag, and this time some embodiments of the present disclosure use x+1. The other compute unit (another stream multi-processor in the same GPU or on another GPU) will know the data is ready when it sees x+1 as the flag, without any additional synchronization. In the latency-optimized kernels, some embodiments of the present disclosure leverage this powerful primitive to reduce synchronization overhead both within and across GPUs.

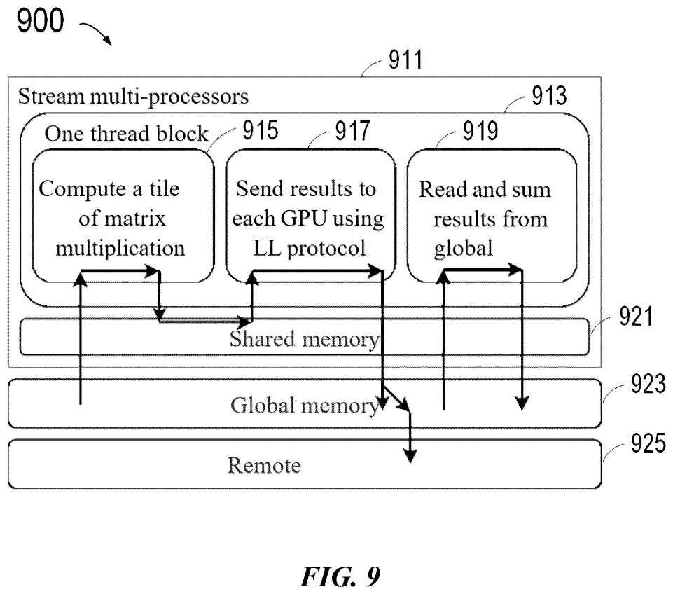

Furthermore, some embodiments of the present disclosure provide methods for fused GEMM with all reduce in details. To further reduce the data movement overhead and save the number of synchronization barriers, some embodiments of the present disclosure fuse each all-reduce operation with the preceding GEMM operation. FIG. 9 shows the computation and data flow of the process 900 within one thread block 913 when some embodiments of the present disclosure run GEMM fused with all reduce. Each thread block 913 of one of the stream multi-processors 911 has three steps during execution: At 915, the thread block calculates a contiguous set of columns in the final result matrix, and stores the final result matrix in the shared memory 921; And at 917, the thread block starts sending the result to each GPU (e.g., remote GPUs 925) using the CCL LL protocol; and at 919, the thread block on each GPU waits until the results are available, aggregates them to get the final results, and stores them back to the global memory 923 on the current GPU. The synchronization between 917 and 919 is implemented using just the CCL LL protocol described above and no additional expensive mechanisms.

Furthermore, some embodiments of the present disclosure provide methods for masked attention. For the mask-attention operators, some embodiments of the present disclosure fuse the position embedding with the attention calculation. Then, within one GPU, some embodiments of the present disclosure first split the computation of the single attention head between different thread blocks. After the calculation, the threadblocks aggregate the sum using the CCL LL protocol within a single GPU. Similar to the fused GEMM with all-reduce operators, some embodiments of the present disclosure add up the results within one attention head without explicit synchronization across thread blocks or extra kernel launches.

Furthermore, some embodiments of the present disclosure provide fused SwiGLU. This operator is of the form SwiGLU(x, W, V, b, c)=σ(xW+b)⊕(xV+c). Some embodiments of the present disclosure implement tile-based matrix multiplication, where each threadblock calculates the same tile of the two matrix multiplications. This avoids loading the input twice from the GPU HBM. Right after some embodiments of the present disclosure get the output of the tiles, some embodiments of the present disclosure calculate the sigmoid and dot product before putting the results back to the GPU memory, avoiding unnecessary data movement.

In this way, after multiple comparative experiments, it can be concluded that increasing the decoding speed of LLMs by scaling speculative decoding is important yet challenging for reducing end-to-end request latency. Some embodiments of the present disclosure provide the system, which includes three key innovations: parallel tree generation, consistent KV cache management, and latency-optimized kernels. Combining those three techniques, some embodiments of the present disclosure are able to serve five different models in different model families with an average decoding speed 1.75× faster than the most competitive baselines. Particularly, The present disclosure can serve the LLM on an average of 348 tokens per second, which may be currently the fastest system using GPUs. And the parallel tree generation with KV cache consistency and fused operator strategies are general and independent of the particular model families.

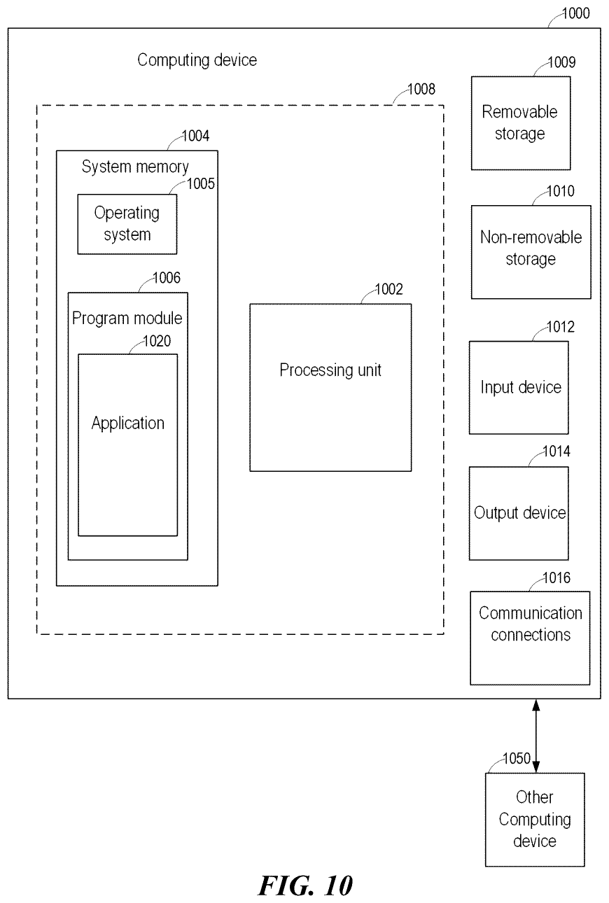

FIG. 10 is a block diagram illustrating physical components (e.g., hardware) of an electronic device 1000 with which aspects of the disclosure may be practiced. For example, the electronic device 1000 may implements the processes as depicted in FIG. 2 etc. In a basic configuration, the processing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories.

The system memory 1004 may include an operating system 1005 and one or more program modules 1006 suitable for performing the various aspects disclosed herein such. The operating system 1005, for example, may be suitable for controlling the operation of the processing device 1000. Furthermore, aspects of the disclosure may be practiced in conjunction with other operating systems, or any other application program and is not limited to any particular application or system. This basic configuration is illustrated in FIG. 10 by those components within a dashed line 1008. The processing device 1000 may have additional features or functionality. For example, the processing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, several program modules and data files may be stored in the system memory 1004. While executing on the at least one processing unit 1002, an application 1020 or program modules 1006 may perform processes including, but not limited to, one or more aspects, as described herein. The application 1020 may include an application interface 1021 which may be the same as or similar to the application interface 1021 as previously described in more detail with regard to FIG. 2 etc. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the processing device 1000 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The processing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The processing device 1000 may include one or more communication connections allowing communications with other computing or processing devices 1050. Examples of suitable communication connections include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the processing device 1000. Any such computer storage media may be part of the processing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a non-transitory storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub-combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method, comprising:
receiving a plurality of verified tokens;
generating, by a first model and based on the plurality of verified tokens, a plurality of candidate tokens; and
sending the plurality of candidate tokens to a second model,
wherein the first model is allocated to at least one first processor, and the second model is allocated to at least one second processor, and the computation of the second model is carried out in parallel during the computation of the first model.

2. The method according to claim 1, wherein generating, by the first model and based on the plurality of verified tokens, the plurality of candidate tokens comprises:
traversing a draft tree, wherein the draft tree comprises the plurality of candidate tokens; and
re-rooting, based on the plurality of verified tokens, the draft tree.

3. The method according to claim 2, wherein generating, by the first model and based on the plurality of verified tokens, the plurality of candidate tokens further comprises:
expanding the draft tree,
wherein sending the plurality of candidate tokens to the second model comprises:
in response to the number of the nodes of the draft tree being greater than or equal to a sending threshold, sending a sub-graph of the draft tree to the second model.

4. The method according to claim 1, wherein based on the types of the first model and the second model, a number of the at least one first processor for the first model and a number of the at least one second processor for the second model are determined at a computing node.

5. The method according to claim 1, wherein a number of parameters of the second model is greater than a number of parameters of the first model.

6. The method according to claim 2, wherein a batch size of the draft tree is determined based on a total running time of the first model and the second model.

7. The method according to claim 2, wherein a number of tree expansions of the draft tree is determined based on a total running time of the first model and the second model in one iteration.

8. The method according to claim 2, further comprising:
dividing a Key-Value (KV) cache of the first model into a prefix segment and a tree cache segment, wherein the prefix segment is used to store KV states of the plurality of verified tokens of the draft tree, and the tree cache segment is used to store KV states of remaining nodes of the draft tree.

9. The method according to claim 8, wherein generating, by the first model and based on the plurality of verified tokens, the plurality of candidate tokens comprises:
updating, based on the plurality of verified tokens, the prefix segment of the KV cache of the first model;
in response to the plurality of verified tokens existing in the re-rooted draft tree, storing KV states of remaining nodes of the re-rooted draft tree in the tree cache segment.

10. The method according to claim 9, wherein storing KV states of remaining nodes of the re-rooted draft tree in the tree cache segment comprises:
deleting at least one of KV states of the plurality of verified tokens from the tree cache segment.

11. The method according to claim 3, wherein generating, by the first model and based on the plurality of verified tokens, a plurality of candidate tokens further comprises:
in response to the number of the nodes of the draft tree being less than a sending threshold, expanding the draft tree to obtain the plurality of candidate tokens.

12. The method according to claim 1, further comprising:
determining at least one result matrix of the first model on a current processor of the at least one first processor;
sending the at least one result matrix to all the other processors of the at least one first processor.

13. The method according to claim 12, further comprising:
in response to receiving the at least one result matrix, aggregating the at least one result matrix to get at least one final result on at least one of all the other processors; and
sending the at least one final result to a global memory of the current processor.

14. The method according to claim 13, wherein the at least one first processor and the at least one second processor are Graphics Processing Units (GPUs), and the GPUs use a protocol to send the at least one result matrix.

15. The method according to claim 1, further comprising at least one of:
fusing position embedding with an attention calculation for mask-attention operators for the computation of the first model; or
fusing Swish-Gated Linear Unit (SwiGLU) operator based on a tile-based matrix multiplication for the computation of the first model.

16. A method, wherein a first model is allocated to at least one first processor, and a second model is allocated to at least one second processor, and the at least one first processor is used for computation of the first model, and the at least one second processor is used for computation of the second model respectively, and the computation of the second model is carried out in parallel during the computation of the first model, the method comprising:
receiving a plurality of candidate tokens;
verifying, by the second model, the plurality of candidate tokens; and
sending the plurality of verified candidate tokens to the first model.

17. The method according to claim 16, wherein verifying, by the second model, the plurality of candidate tokens comprises:
determining a probability distribution of the plurality of candidate tokens of the sub-graph of the draft tree;
sampling the probability distribution of the plurality of candidate tokens of the sub-graph of the draft tree; and
determining, based on the sampled probability distribution of the plurality of candidate tokens, the plurality of verified tokens.

18. The method according to claim 16, wherein based on the types of the first model and the second model, a number of the first processors for the first model and a number of the second processors for the second model are determined at a computing node, and a number of parameters of the second model is greater than a number of parameters of the first model.

19. An electronic device, comprising:
a memory and a processor;
wherein the memory is configured to store one or more computer instructions which, when executed by the processor, cause the processor to:
receive a plurality of verified tokens;
generate, by a first model and based on the plurality of verified tokens, a plurality of candidate tokens; and
send the plurality of candidate tokens to a second model,
wherein the first model is allocated to at least one first processor, and the second model is allocated to at least one second processor, and the at least one first processor is used for computation of the first model, and the at least one second processor is used for computation of the second model respectively, and the computation of the second model is carried out in parallel during the computation of the first model.

20. The device according to claim 19, wherein the one or more computer instructions causing the processor to generating, by the first model and based on the plurality of verified tokens, the plurality of candidate tokens comprise instructions to:
traverse a draft tree, wherein the draft tree includes the plurality of candidate tokens; and
re-root, based on the plurality of verified tokens, the draft tree.
